(19) United States
(12) Patent Application Publication
(10) Pub. No.: US 2013/0042399 A1
(43) Pub. Date: Feb. 21, 2013

(54) Apparatus and method for toilet odor reduction and energy generating gas vapor control

(71) Applicants: Robert Fred Smith, Parachute, CO (US); Will Dexter Ball, IV, Bixby, OK (US)

(72) Inventors: Robert Fred Smith, Parachute, CO (US); Will Dexter Ball, IV, Bixby, OK (US)

(21) Appl. No.: 13/211,323

(22) Filed: Aug. 17, 2011

(51) Int. Cl. E03D 9/04; F16L 3/01

(52) U.S. Cl. 4/347; 137/561 R

(57) ABSTRACT

Apparatus and method for reducing odor from a toilet bowl having an air cushion bladder seat with an orifice for passing air out of and into the bladder as a person sits down and rises from the air cushion bladder seat which is coupled to operate a switching valve. The switching valve has a first tube that connects the area above the water in the bowl to a second tube coupled to a gas/vapor moving means and disconnects a third tube that connects the toilet trap from the second tube as a person sits down on the air cushion bladder seat. The gas/vapor moving means is coupled to the second tube which to feed the gas/vapor to a fuel/air mixer of a combustion chamber for burning the gas/vapor with the fuel.

### BACKGROUND OF THE INVENTION

1. Field of the Invention

The present invention relates generally to a toilet and more specifically to a toilet odor and a sewer gas recovery system that is simple, requires little or no periodic maintenance, manages itself and is more efficient and reliable than other toilet odor and sewer gas recovery system.

2. Description of Related Art

The reduction of toilet odors is known in the prior art. More specifically, by way of example, U.S. PreGrant Publication No. 2010/019413 to Pollack; et al. discloses a fan assembly for directing air from a toilet bowl and has an overflow tube for passing gas through a filter upon instruction from a mechanism designed to determine when the toilet is in use.

U.S. PreGrant Publication No. 2010/0077543 to Hofmann discloses a seal between the cistern and the tank lid capable of forming a substantially airtight seal between the cistern and the tank lid with a pathway for the flow of air from the interior of the toilet bowl to the interior of the toilet tank; and an opening in the toilet tank for exhausting air from the toilet tank.

U.S. PreGrant Publication No. 2009/0158515 to Bruno discloses a portable odor removal system that allows the toilet bowl area to retain and produce fresh air while simultaneously venting noxious air that is produced during use where the system is easily carried.

U.S. PreGrant Publication No. 2006/0117471 to Hofmann discloses an opening which is coplanar with an inner surface of a toilet bowl and an exhaust channel that extends from the opening to which an exhaust line is attached which extends from the exhaust channel to an outdoor ventilation space; and an exhaust device for moving gas from the toilet bowl.

U.S. Pat. No. 7,331,066 to Ramos discloses drawing gas from a bowl into a separate exhaust manifold within the rim structure of the toilet bowl. The air is then transferred to the exterior of the building or to a scrubbing system using a fan and motor and an evacuation conduit system.

U.S. Pat. No. 6,928,666 to Schaffer discloses an enlarged vent pipe located in the water tank that communicates with the upper rim ducts in the toilet bowl. The vent pipe extends out of the water tank and reenters the toilet via the drain channel at a location downstream of the trap. The vent pipe has a float valve in the water tank to prevent the tank from overflowing and a fan in the vent pipe exhausts the air from the toilet bowl.

U.S. Pat. No. 6,795,980 to Ries discloses a fan housed within a toilet seat lid, an intake passage created when the seat is down and the lid is raised, a stationary outflow duct through which evacuated air is driven, and a switch for activation of the fan.

U.S. Pat. No. 6,546,567 to Kuzniar discloses a seat containing an entire ventilation system including an intake, an air plenum positioned within the seat, an air filter positioned within the air passage, and a fan to move air through the air passage where the filtered air exits through an edge of the seat. The blower fan is controlled by a battery pack contained within the seat.

### SUMMARY OF THE INVENTION

In an exemplary embodiment of the present invention, there is disclosed apparatus for reducing odor from a conventional toilet bowl comprising:

a seat having an air cushion bladder pivotally attached to the toilet bowl;

an orifice located in the air cushion bladder for passing air out of the bladder as a person sits down on the bladder and for passing air into the bladder as a person rises from the bladder;

an air operated valve coupled to the orifice adapted to move from a rest position to a first position as a person sits down on the seat and to return to its rest position as the person rises from the seat;

a switching valve coupled to the air operated valve having a first tube that connects the area above the water in the bowl to a second tube coupled to a gas/vapor moving means and to disconnect a third tube that connects the toilet trap from the second tube as the air operated valve moves from its rest position to its first position; and

a gas/vapor moving means coupled to the second tube which is coupled to feed the gas/vapor to a fuel/air mixer of a combustion chamber for burning the gas/vapor with the fuel.

In an exemplary embodiment of the present invention, there is disclosed apparatus for collecting and burning hydrocarbons from a municipal sewer waste pipe located below street level comprising;

locating a tube having a plurality of openings at the waste pipe;

connecting to the tube a vapor/gas collection pipe that extends up through a person cover to a low pressure vapor/gas mover means which is coupled to move the vapor/gas to a fuel air mixer on a municipal boiler.

In an exemplary embodiment of the present invention, there is disclosed a method for reducing odor from a conventional toilet bowl comprises:

providing a seat having an air cushion bladder pivotally attached to the toilet bowl;

locating an orifice in the air cushion bladder for passing air out of the bladder as a person sits down on the bladder and for passing air into the bladder as a person rises from the bladder;

coupling an air operated valve to the orifice which moves from a rest position to a first position as a person sits down on the seat and to return to its rest position as the person rises from the seat;

coupling a switching valve to the air operated valve which has a first tube that connects the area above the water in the bowl to a second tube coupled to a gas/vapor moving means and to disconnect a third tube that connects the toilet trap from the second tube as the air operated valve moves from its rest position to its first position; and

coupling a gas/vapor moving means to the second tube which is coupled to feed the gas/vapor to a fuel/air mixer of a combustion chamber for burning the gas/vapor with the fuel.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side partial sectional elevational view of a toilet bowl in accordance with the principles of the invention;

FIG. 2 is an enlarged side view of the toilet seat located on the top of the toilet bowl of FIG. 1;

FIG. 3 is a schematic plumbing diagram showing a switching valve which is operated when a person sits down on the toilet seat of FIG. 1 to control the flow of gas out from the toilet to a water heater or furnace in accordance with the principles of the invention;

FIG. 4 is a side sectional view of the eccentric check valve and solar powered low voltage gas/vapor mover located in the duct from the toilet bowl to the water heater or furnace in accordance with the principles of the invention; and

FIG. 5 is an embodiment of the invention where a low pressure fan moves gas/vapor from a municipal sewer system to fuel-air mixers on at least one municipal boiler prior to sending the hot products of combustion to a waste heat recover system in accordance with the principles of the invention.

### DESCRIPTION OF THE PREFERRED EMBODIMENT

As the American society assumes the role of becoming more environmentally sensitive to the need for out of the box thinking, concepts such as 1) Wind power to reduce green house gas emission and fossil fuel usage; 2) Federally funded home insulation programs to reduce fossil fuel usage; 3) Hybrid and fully electric cars to reduce green house gas emissions and fossil fuel usage, and; 4) Solar collectors to reduce greenhouse gas emissions and fossil fuel usage move to the forefront of the thinking today. In addition to the above, other opportunities to forward the green approach includes; 1) The need to conserve and reduce the use of fossil fuels in everyday life; 2) A desire to improve the quality of life globally, and; 3) The availability of a heretofore untapped resource.

The invention here disclosed relates to the above by capturing gasses generated each day by all living human beings. In the past several centuries societies throughout the world have made the transition to waste collection at the most local level. Toilets abound in the entire civilized world today. This provides a means to collect solid and liquid waste. This invention enlarges this to include the collection of all vapor/gas phase waste as well.

This invention discloses the making of minor modifications to conventional toilets so that the associated vapors/gases can be quietly and invisibly collected. The driving force for this was originally thought to be the reduction of offensive odors from all households, municipal buildings, offices, and institutions. However, as the subject of reducing the uses of fossil fuels pervaded society, the emphasis shifted to energy reduction while improving quality of life through odor reduction/mitigation.

The inventors now envision a world where all new toilets include the invention here disclosed and where all existing toilets are retrofitted with the invention disclosed to 1) Remove all vapors from toilets as they are generated to minimize offensive odors and; 2) Move all vapors to energy consuming fixtures which already exist in most residences, municipal buildings, offices, and institutions where they contribute to the fuel needs and reduce the use of conventional fossil fuels.

The invention disclosed accomplishes the above with a small solar powered vane axial fan, or series of fans which are located in small diameter, inexpensive ductwork. The fans pull the vapors out of the toilet areas continuously as they are generated, and at no operating cost.

In another embodiment, to increase the fuel value of collected vapors, vapors are gathered form the piping down stream of the toilet(s) during periods when the toilets are not in use. Odor reduction/elimination and fuel usage reductions are accomplished as follows: the odor causing gases are a mixture of hydrocarbons which is a fuel. Therefore, these odors are ducted to a fuel consuming device already present in most of the target environs, These include gas fired hot water heaters where the hydrocarbons present in the collected vapors offset the need for added natural gas fuel which reduces fuel usage and associated costs.

In another embodiment of the invention where no fossil fuel is currently in use, the collected vapors may be vented to the atmosphere where they are diluted beyond the threshold of human detection thus increasing the quality of life of all in proximity of the retrofitted facility and, in addition, creates useable power for everyone. Preferably, the collected vapors are sent to a co-generation unit, a unit that can use the collected vapors to generate green electricity.

Any convention toilet currently in use can be retrofitted with the invention disclosed to eliminate offensive odors and collect vapors that can be used as a fuel by using the following: a flapper valve for each existing toilet, a vapor sealing toilet seat for each existing toilet, a diamond drill for making two new vapor release openings in each exiting toilet ceramic casting, a self sealing hose fittings for each existing toilet, a small diameter duct from each existing toilet to a vapor check valve fan assembly, and a duct to an appropriate gas fired heater or outside vent.

It is estimated that the capital cost for converting one toilet with the invention disclosed will be returned to the owner in full in less than three and one-half years which provides a very attractive return on investment. This means that the owner's fuel costs will be reduced for the life of the toilet, adding cash flow to the owner for life. In addition, with all vapors and associated odors completely eliminates, the invention will have improved the owner's quality of life and the quality of life of all users of the owner's facilities from the very first day.

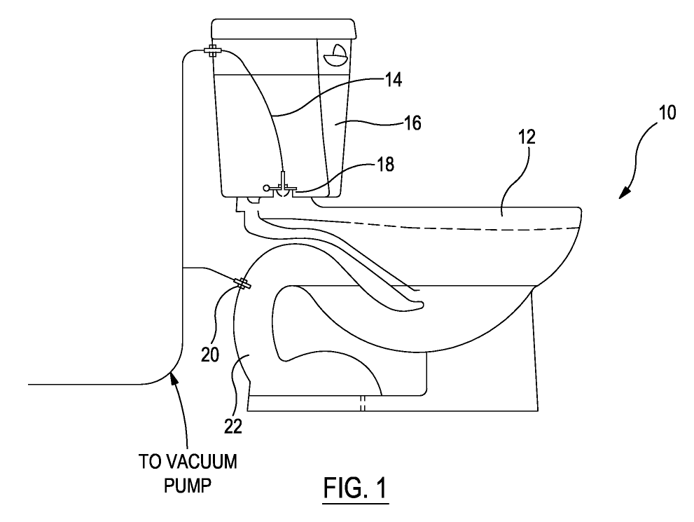

Referring to FIG. 1, there is disclosed a side partial sectional elevational view of a conventional toilet bowl 10 with a self sealing seat 12 and toilet vent vacuum hose connections which are connected to a vacuum pump in accordance with the principles of the invention. One vacuum hose 14 which is locater in the water reservoir 16 has a first end that terminates at a vacuum valve 18 which is located to suck gas/vapor from between the self sealing toilet bowl seat and the water in the bowl. The other end of the vacuum hose is located at the rear of the water reservoir and above the water level of the water in the reservoir. A second vacuum valve 20 is located in the toilet bowl trap 22 for receiving gas/vapor from a sewer line or a septic tank. The two vacuum valves 18, 20 are connected via a common tube such as a five eighth inch copper tube to a vacuum pump.

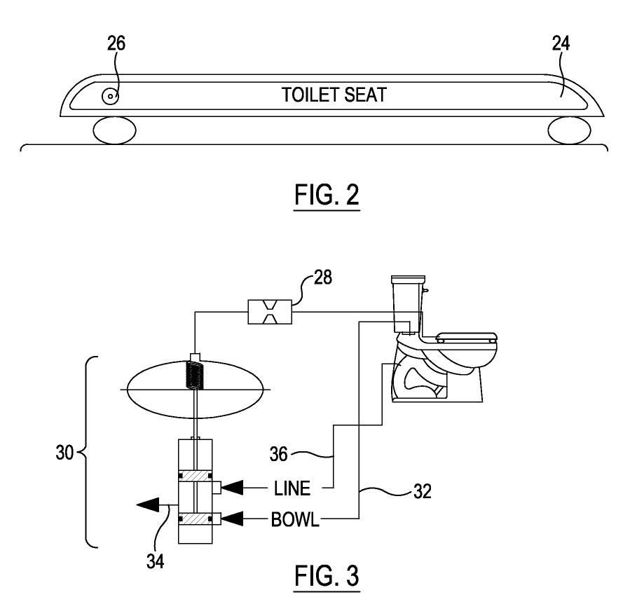

Referring to FIG. 2, there is shown an enlarged side view of the toilet seat of FIG. 1 having an air cushion bladder 24 which, when a person sits on the toilet seat, feeds air through an orifice 26 which urges an air operated valve (valve 28 in FIG. 3) to be displaced from its at rest position to a first position, and when a person rises from the toilet seat, sucks air through the orifice flow control to urge the air operated valve to return to its at rest position. The air operated valve is coupled to a switching valve 30 shown in FIG. 3

Referring to FIG. 3, there is shown a schematic plumbing diagram of the air operated valve 28, and switching valve 30 which is operated when a person sits down or rises up from the toilet seat. When a person sits down on the toilet seat, air pressure from the toilet seat moves the diaphragm in the switching valve 30 down which allows gas/vapor located between the person seating on the toilet seat and the water in the bowl to be sucked through duct 32 to duct 34 that is connected to a water heater or furnace and, at the same time prevents gas/vapor from the trap in the toilet bowl from being sucked through duct 36 to duct 34 that is connected to a water heater or furnace. When the person rises from the toilet seat, air pressure from the toilet seat is removed from the diaphragm in the switching valve and a spring located on the switching valve moves the diaphragm up which prevents gas/vapor located above the water in the bowl to be sucked into the duct that is connected to a water heater or furnace and, at the same time allows gas/vapor from the trap in the toilet bowl to be sucked into the duct that is connected to the water heater or furnace.

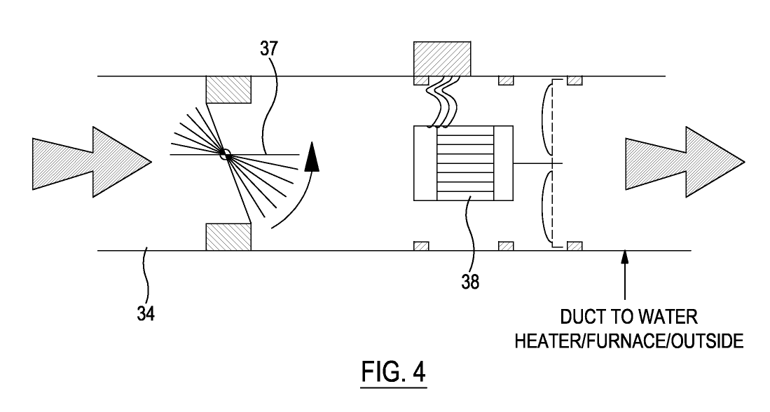

Referring to FIG. 4, there is shown a side sectional view of the duct 34 connected to a water heater or furnace, not shown. Duct 34 contains a soft seat eccentric swing check valve 37 located down stream of a solar powered low voltage vapor louvered gas/vapor mover fan 38.

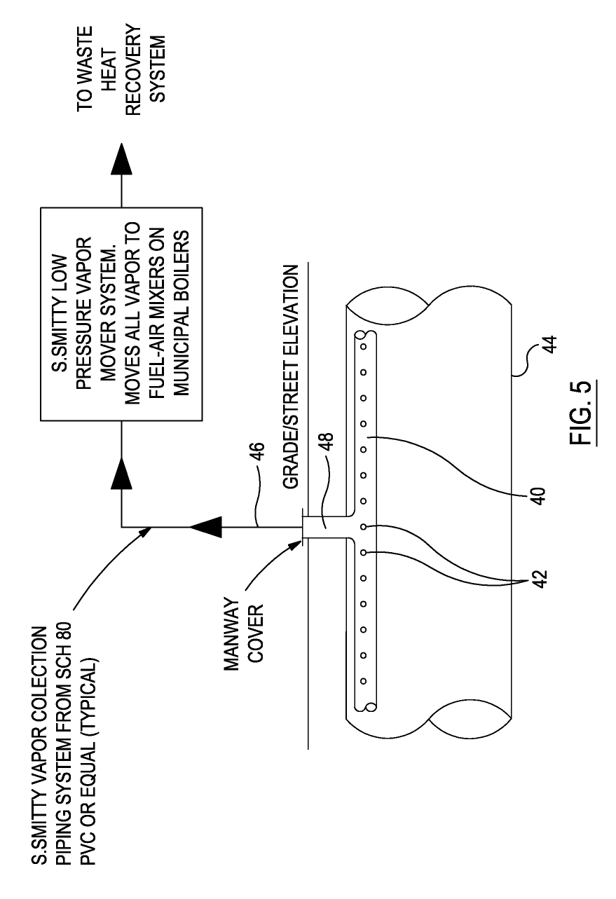

Looking at FIG. 5, there is shown an embodiment of the invention where a low pressure fan moves gas/vapor from a waste pipe of a municipal sewer system to a fuel-air mixer on at least one municipal boiler prior to sending the hot products of combustion to a waste heat recover system. In this embodiment of the invention a tube which may be made of a plastic such as PVC or equal having a plurality of openings 42 and which may have sealed or open ends is located at the top of a municipal sewer pipe 44 which is carrying waste matter. Tube 40 is located above the liquid waste that flows through pipe 44 and is connected to a gas/vapor collection pipe 46 that may pass through a grade/street level person or manway cover to a low pressure vapor mover system that moves all gas/vapor in the pipe 44 to at least one fuel air mixer on municipal boilers. The hot products of combustion from the municipal boilers may be fed to a waste heat recovery system. A check valve 48 may be located in the vapor/gas collection pipe 46 to prevent liquid waste from entering the vapor/gas collection pipe 46 during the occurrence of a flood condition

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. Apparatus for reducing odor from a conventional toilet bowl comprising:
a seat having an air cushion bladder pivotally attached to the toilet bowl;
an orifice located in the air cushion bladder for passing air out of the bladder as a person sits down on the bladder and for passing air into the bladder as a person rises from the bladder;
an air operated valve coupled to the orifice adapted to move from a rest position to a first position as a person sits down on the seat and to return to its rest position as the person rises from the seat;
a switching valve coupled to the air operated valve having a first tube that connects the area above the water in the bowl to a second tube coupled to a gas/vapor moving means and to disconnect a third tube that connects the toilet trap from the second tube as the air operated valve moves from its rest position to its first position; and
a gas/vapor moving means coupled to the second tube which is coupled to feed the gas/vapor to a fuel/air mixer of a combustion chamber for burning the gas/vapor with the fuel.

2. The apparatus of claim 1 wherein a vacuum tube located in the toilet bowl tank has a first end that is connected to the first tube and a second end that is coupled to receive gas/vapor from above the water in the toilet bowl.

3. The apparatus of claim 2 wherein the second end of the vacuum tube is attached to a vacuum valve.

4. The apparatus of claim 3 wherein the first end of the vacuum tube is attached to the first tube at the top of the tank.

5. The apparatus of claim 4 wherein the second end of the vacuum tube is attached to the first tube above the water in the tank.

6. The apparatus of claim 5 wherein the second tube includes a soft seat check valve.

7. The apparatus of claim 6 wherein the soft seat check valve is an eccentric swing check valve.

8. The apparatus of claim 7 wherein the gas/vapor moving means includes a solar powered low voltage vapor/gas louver mover.

9. The apparatus of claim 8 wherein the solar powered low voltage vapor/gas louver mover is a fan.

10. The apparatus of claim 9 wherein a waste heat recovery device is coupled to the combustion chamber.

11. Apparatus for collecting and burning hydrocarbons from a municipal sewer waste pipe located below street level comprising;
locating a tube having a plurality of openings at the waste pipe.
connecting to the tube a vapor/gas collection pipe that extends up through a person cover to a low pressure vapor/gas mover means which is coupled to move the vapor/gas to a fuel air mixer on a municipal boiler.

12. The apparatus of claim 11 wherein a check valve is located in the vapor/gas collection pipe to prevent liquid waste from entering the vapor/gas collection pipe.

13. A method for reducing odor from a conventional toilet bowl comprises:
providing a seat having an air cushion bladder pivotally attached to the toilet bowl;
locating an orifice in the air cushion bladder for passing air out of the bladder as a person sits down on the bladder and for passing air into the bladder as a person rises from the bladder;
coupling an air operated valve to the orifice which moves from a rest position to a first position as a person sits down on the seat and to return to its rest position as the person rises from the seat;
coupling a switching valve to the air operated valve which has a first tube that connects the area above the water in the bowl to a second tube coupled to a gas/vapor moving means and to disconnect a third tube that connects the toilet trap from the second tube as the air operated valve moves from its rest position to its first position; and
coupling a gas/vapor moving means to the second tube which is coupled to feed the gas/vapor to a fuel/air mixer of a combustion chamber for burning the gas/vapor with the fuel.

14. The method of claim 13 wherein a vacuum tube located in the toilet bowl tank has a first end that is connected to the first tube and a second end that is coupled to receive gas/vapor from above the water in the toilet bowl.

15. The method of claim 14 wherein the second end of the vacuum tube is attached to a vacuum valve.

16. The method of claim 15 wherein the first end of the vacuum tube is attached to the first tube at the top of the tank.

17. The method of claim 16 wherein the second end of the vacuum tube is attached to the first tube above the water in the tank.

18. The method of claim 17 wherein the second tube includes a soft seat check valve.

19. The method of claim 18 wherein the soft seat check valve is an eccentric swing check valve.
